(19) United States
(12) Patent Application Publication
(10) Pub. No.: US 2015/0083886 A1
(43) Pub. Date: Mar. 26, 2015

(54) ADJUSTABLE HAIR DRYER HOLDER

(71) Applicant: NEXT FUTURE LLC, Dublin, OH (US)

(72) Inventors: Ellen M. BROWN, Columbus, OH (US); James L. KENNEDY, Dublin, OH (US); Julia MCDEVITT, Columbus (OH); Charles R. PATZER, Columbus, OH (US)

(73) Assignee: NEXT FUTURE LLC, Dublin, OH (US)

(21) Appl. No.: 14/497,409

(22) Filed: Sep. 26, 2014

Related U.S. Application Data
(60) Provisional application No. 61/883,028, filed on Sep. 26, 2013.

(51) Int. Cl. A45D 20/00; F16M 13/02

(52) U.S. Cl. CPC A45D 20/00; F16M 13/02
USPC 248/664; 29/428; 248/674

(57) ABSTRACT

Disclosed is a hair dryer holder for supporting a hair dryer in a fixed position. The hair dryer includes a handle portion and a blower portion. The hair dryer holder includes a base portion for securing the hair dryer holder to a surface and a retainer portion for holding the hair dryer in a fixed position, the retainer includes an opening for receiving the handle portion of the hair dryer and a ring extending at least partially around the opening for supporting the blower portion of the portable hair dryer. The ring further includes a plurality of recessed sections for supporting the blower portion of the portable hair dryer in a fixed position.

### CROSS REFERENCE TO RELATED APPLICATION

This application claims priority to and the benefit of U.S. Provisional Patent Application No. 61/883,028 filed Sep. 26, 2013, which is incorporated herein by reference.

### BACKGROUND AND SUMMARY

The present disclosure relates to a portable appliance holder and more specifically a hair dryer holder that is capable of holding a portable hair dryer in a fixed position.

Hair dryers as styling aides are well used by both women and men in creating artful and decorative hair styles. However, in creating such a hair style, it may be necessary for the user to use both hands, for example one hand holding the hair and one hand holding the brush. This makes use of a portable hair dryer complicated as the user is required to juggle different elements. This difficulty is exacerbated for those individuals with physical limitations, whether due to age, injury or a disability. Limitations in mobility including strength, reach, dexterity or flexibility, may increase the difficulty in holding a hair dryer in the desired position for the duration of a hair styling session. As a result, some individuals who would otherwise be able to perform their own hair styling may be forced to forego the style of their choice or else hire a professional stylist to provide the service for them.

A number of hair dryer holders are available, such as that described by U.S. Pat. No. 4,696,447. This hair dryer holder describes an apparatus that includes a base for attaching to a wall and a retainer assembly to receive a portable hair dryer. A pivot is positioned between the base and the retainer assembly to provide for angular adjustment of the retainer assembly. While this apparatus solves the problem of retaining a portable hair dryer, allowing for hands-free use, the apparatus does not solve all of the problems of using a portable hair dryer. Specifically, the devices does not provide for means of holding the portable hair dryer in a fixed orientation.

In view of the limitations of previously available products, there remains a need for a hair dryer holding apparatus that is capable of retaining a portable hair dryer in a fixed position. There also remains a need for a hair dryer holding apparatus that is usable by those individuals with reduced mobility or other physical limitations so that such people are not forced to forego the style of their choice or turn to paid professionals due to their physical limitations

Presently disclosed is a hair dryer holder for securing a hair dryer having a handle portion and a blower portion. In embodiments, the hair dryer holder includes a base portion configured to secure the hair dryer holder to a surface; and a retainer portion pivotally secured to the base portion and configured to hold the hair dryer in a fixed position, wherein the retainer portion includes an opening configured to receive the handle portion of the hair dryer and a ring extending at least partially around the opening, with the ring having a plurality of recessed sections with each of the plurality of recessed sections configured to support the blower portion of the portable hair dryer in a fixed position.

The ring of the hair dryer holder in another embodiment may further comprise a top surface having rounded undulations defining a plurality of raised sections alternating between the plurality of recessed sections. In some embodiments, the rounded undulations may be sinusoidal.

In some embodiments, the ring of the hair dryer holder may further comprise a top surface having a textured surface defining the plurality of recessed sections. In some embodiments, the ring of the hair dryer holder further comprises a top surface defining a plurality of raised ridges alternating between the plurality of recessed sections. In some embodiments, the ring of the hair dryer holder further comprises a cord opening disposed opposite the base portion and configured to receive a cord of the hair dryer.

In some embodiments, the cord opening of the hair dryer holder is sized to receive the handle portion of the hair dryer.

In some embodiments, the base portion of the hairdryer holder includes a base opening configured to receive a fastener for securing the hair dryer holder to a surface. In some embodiments, the fastener of the hair dryer holder comprises a suction cup.

The hair dryer holder may further comprise an arm pivotally secured to the base portion and connecting to the retainer portion, such that the retainer portion is pivotally secured to the base portion.

Also disclosed is a method of fixing a hair dryer in place. In some embodiments, the method includes the steps of: providing a hair dryer having a handle portion and a blower portion; providing a hair dryer holder for supporting the hair dryer, the hair dryer holder including: a base portion configured to secure the hair dryer holder to a surface; and a retainer portion pivotally attached to the base portion and configured to hold the hair dryer in a fixed position, the retainer including an opening configured to receive the handle portion of the hair dryer and a ring extending at least partially around the opening, the ring comprising a plurality of recessed sections with each of the plurality of recessed sections configured to support the blower portion of the hair dryer in a fixed position; inserting the handle of the portable hair dryer through the opening in the retainer portion of the holder; automatically rotating the hair dryer so that the blower portion is received within one of the plurality of recessed sections; and adjusting the position of the retainer portion.

In some embodiments, the base portion used in the method of fixing a hair dryer in place may further comprise a fastener for securing the hair dryer holder to a surface.

In some embodiments, the ring used in the method of fixing a hair dryer in place further comprises a top surface having sinusoidal undulations defining a plurality of raised sections alternating between the plurality of recessed sections, and wherein the hair dryer is automatically rotated into one of the plurality of recessed sections by the force of gravity. In some embodiments, the ring used in the method of fixing a hair dryer in place further comprises a cord opening disposed opposite the base portion and configured to receive a cord of the hair dryer. In even another embodiment, the ring used in the method of fixing a hair dryer in place further comprises a top surface having a textured surface defining the plurality of recessed sections, and wherein the hair dryer is automatically rotated into one of the plurality of recessed sections by the force of gravity.

In another embodiment, the method of fixing a hair dryer in place further comprises an arm pivotally secured to the base portion and connecting to the retainer portion, such that the retainer portion is pivotally secured to the base portion.

Also disclosed is a retainer for securing a portable hair dryer having a handle portion and a blower portion to a base, the retainer comprising: a ring for supporting the blower portion of the portable hair dryer; an opening for receiving the handle portion of the portable hair dryer; a plurality of raised and recessed sections for supporting the blower portion in a fixed position. In some embodiments, the plurality of raised and recessed sections of the retainer comprise sinusoidal undulations.

### BRIEF DESCRIPTION OF DRAWINGS

FIG. 1 is a perspective view of the hair dryer holder in use supporting a portable hair dryer;

FIG. 2 is a perspective view of the hair dryer holder;

FIG. 3A is a perspective view of the retainer portion of the hair dryer holder;

FIG. 3B is a perspective view of an alternative embodiment of the retainer portion of the hair dryer holder;

FIG. 3C is a perspective view of an alternative embodiment of the retainer portion of the hair dryer holder;

FIG. 3D is a perspective view of an alternative embodiment of the retainer portion of the hair dryer holder; and

FIG. 4 is a perspective view of the base portion of the hair dryer holder.

### DETAILED DESCRIPTION OF THE DRAWINGS

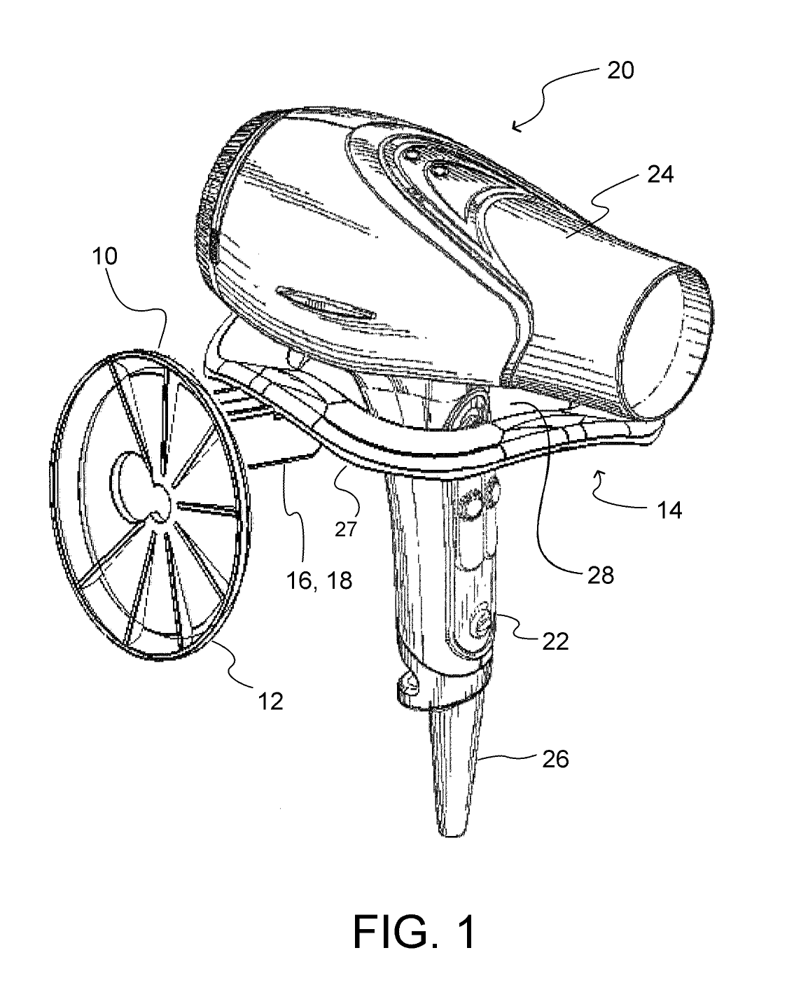

Referring now to the drawings in detail, FIG. 1 illustrates a hair dryer holder for use with a portable or handheld hair dryer in accordance with one embodiment of the present disclosure. The hair dryer holder is generally designated by reference numeral 10, and may be corded or battery operated.

The hair dryer holder 10 includes a base portion 12, a retainer portion 14, and hinge elements 16, 18, coupling the base portion 12 to the retainer portion 14. A portable hair dryer 20 is also provided and includes a handle portion 22, blower portion 24, and cord 26 extending from the handle portion 22. The portable hair dryer 20 is supported by the retainer portion 14 of the hair dryer holder 10 and the base portion 12 is adapted to be attached to a substantially planar surface, such as a wall or minor.

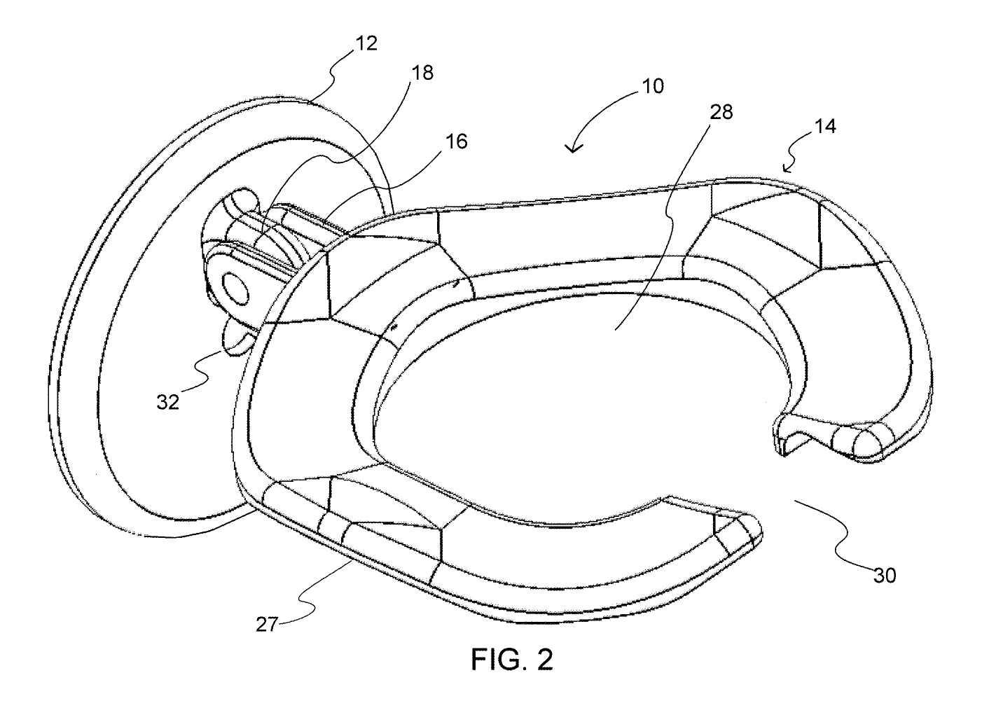

In the illustrated embodiment, the retainer portion 14 includes a ring 27 for supporting the blower portion 24 of the portable hair dryer 20 surrounding a central opening 28 for receiving the handle portion 22 of the portable hair dryer 20. The ring 27 includes structure for supporting the portable hair dryer in a fixed position. The central opening 28 is sized to accept a variety of handle sizes and shapes for accommodating a variety of different portable hair dryer brands. The central opening 28 may also be sized to receive the blower portion 24 of the portable hair dryer 20. In addition to the central opening 28, the retainer portion 14 includes a cord opening 30 (FIG. 2) for receiving the cord 26 of the portable hair dryer 20. FIG. 2 illustrates the hair dryer holder 10 without a portable hair dryer 20 positioned thereon.

As illustrated in FIG. 2, the hair dryer holder 10 includes a base portion 12 and retainer portion 14. The retainer portion 14 includes a first hinge portion 16 and the base portion 12 includes a second hinge portion 18. The first 16 and second hinge portions 18 are adapted to engage one another and allow adjustment of the retainer portion 14 relative to the base portion 12. In the illustrated embodiment, this adjustment is limited to rotating the retainer portion 14 about the hinge 16, 18. Other arrangements between the base 12 and retainer 14 portions are contemplated. In one arrangement, the hinge may be a ball-and-socket joint, or the hinge may have multiple degrees of freedom. Additionally, while the retainer portion 14 is shown as coupled directly to the base portion 12, in other embodiments an arm is provided between the base portion 12 and retainer portion 14. This arm may be rigid, flexible, fixed, or movable between a variety of positions for adjusting the position and angular arrangement of the retainer portion 14.

In addition to the retainer portion 14 being positionable in a variety of orientations by the hinge, the retainer 14 also includes structure for supporting and fixing the portable hair dryer 20 at various orientations. The retainer portion 14 includes a plurality of raised 32A and recessed 32B sections. The recessed sections 32B are positioned between adjacent raised sections 32A. When the blower portion 24 of the portable hair dryer 20 rests on the recessed section 32B the portable hair dryer is prevented from moving by the adjacent raised sections 32A.

Various configurations of raised sections 32A and recessed sections 32B may be used for fixing the position of the portable hair dryer 20 on the ring 27.

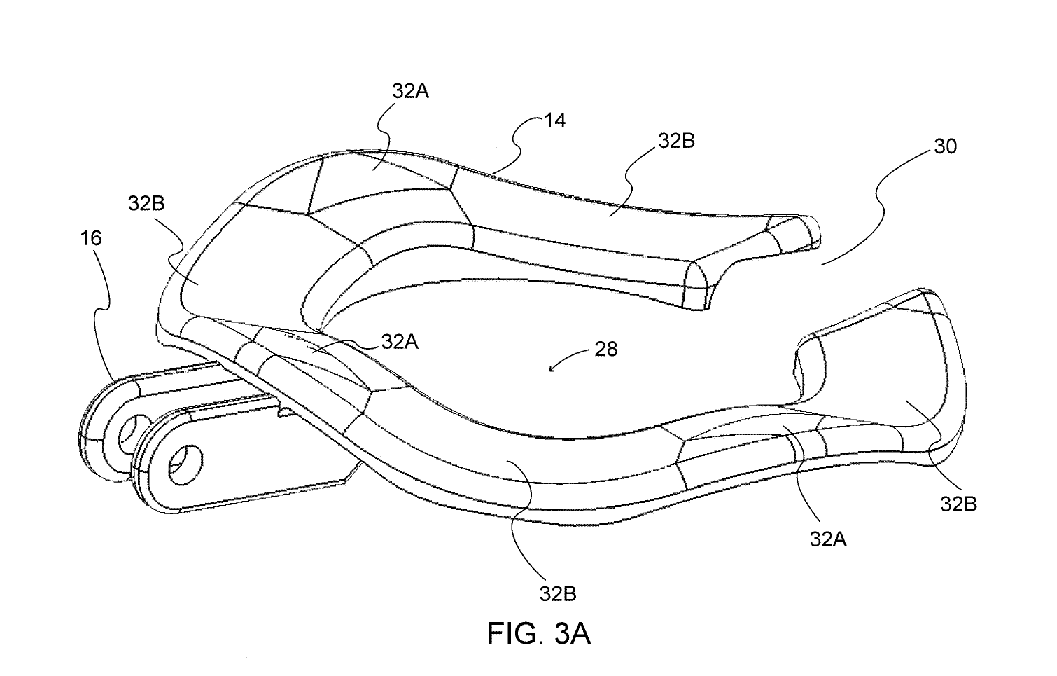

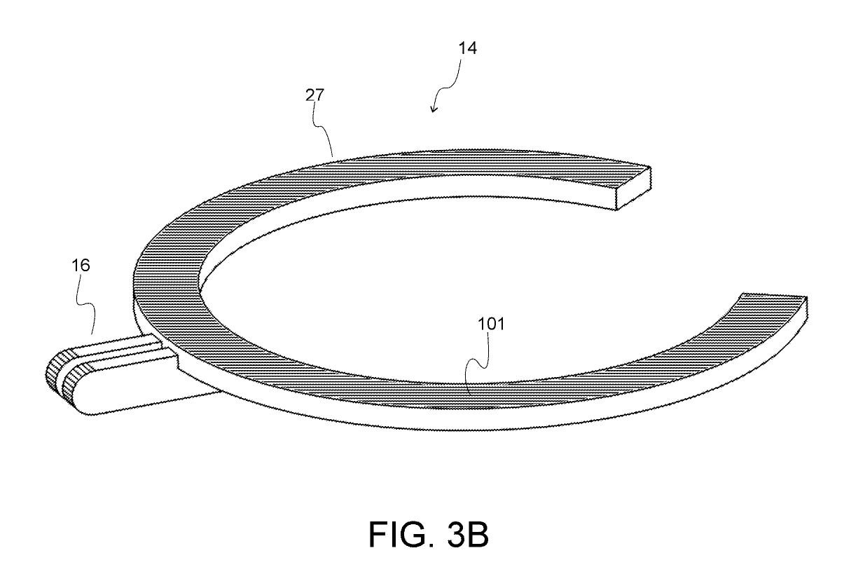

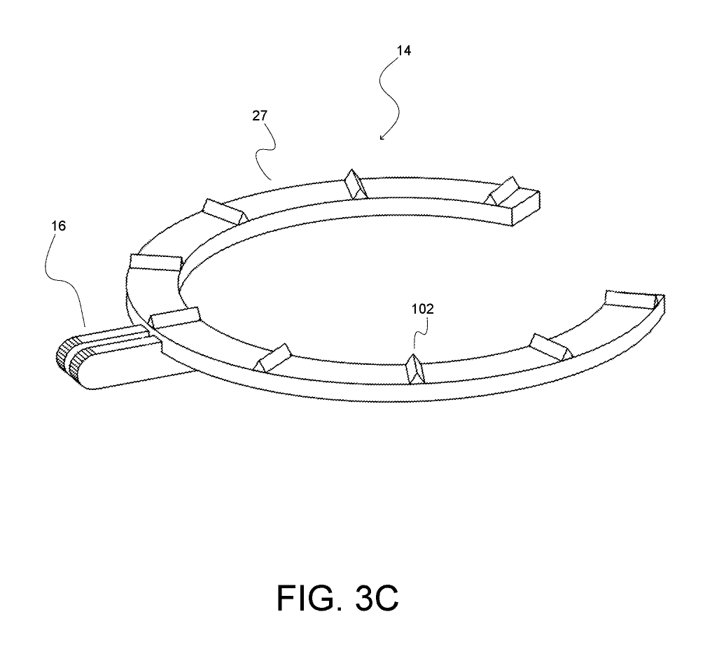

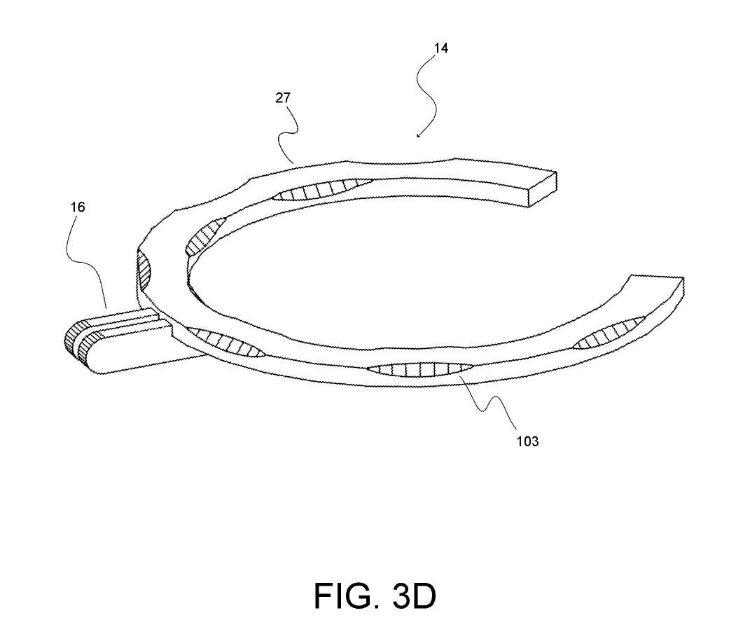

FIG. 3A illustrates an embodiment of a hair dryer retainer portion 14 having a ring 27, a hinge element 16, and rounded undulations forming raised sections 32A and recessed sections 32B. The ring 27 has a rounded top surface, undulating between the raised sections 32A and recessed sections 32B. In this embodiment the top surface has a continuous and smooth surface. In other embodiments, the retainer portion 14 may have a constant thickness so that the bottom surface of the ring 27 also follows a rounded shape. This allows the retainer portion 14 to be usable in different orientations.

FIG. 3B illustrates a hair dryer holder 20 having a hinge 16 and a ring 27, the ring having a textured surface 101. The textured surface 101 defines the structure and shape of the ring 27 and acts to grip a portable hair dryer 20. In some embodiments, the textured surface 101 may be a rubber layer, and in other embodiments may be a large number of small rounded undulations in the surface of the ring 27 forming both recessed sections and raised sections.

FIG. 3C illustrates a hair dryer retainer portion 14 having a ring 27 with raised ridges 102 located on the surface. The raised ridges 102 act to hold the hair dryer 20 in place in the recesses located in between the raised ridges 102. In some embodiments, the raised ridges 102 may be triangular, while in other embodiments the raised ridges 102 may be rounded.

FIG. 3D illustrates an embodiment of a hair dryer retainer portion 14 having a ring 27 with scalloped cuts 103 located on the surface and edges of the ring 27. The scalloped cuts 103 secure the hair dryer 20 in place either by allowing the hairdryer to rest inside the scalloped cuts 103 or alternatively increasing the friction between the ring 27 and the hairdryer 20.

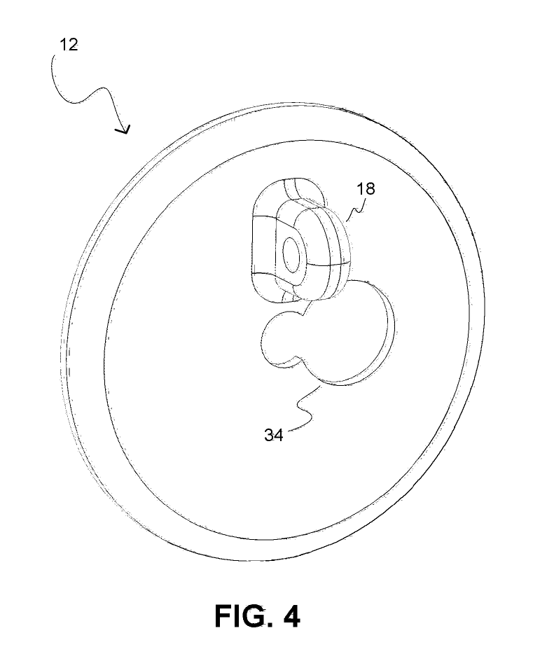

FIG. 4 illustrates an embodiment of a base portion 12. The base portion 12 includes a hinge element 18 complementary to the hinge element 16 of the retainer portion 14. The base portion 12 may also include an opening 34 for attaching the hair dryer holder 10 to a wall. In the illustrated embodiment, the opening 34 includes a hole for receiving a fastener and a slot for securing the fastener. The fastener may be selected from, among others, a suction cup, screw, nail, hook, or other fastener that passes through an opening in the base portion 12. Alternatively, the fastener may be integrally formed with the base portion 12 and may include a suction cup, screw, or other fastener for attaching the base portion 12 to a wall or other flat surface.

The base portion 12 has been generally described as attachable to a flat surface such as a wall, minor, or countertop. However, it is also contemplated that the base portion 12 may be attachable to other surfaces, or may include a weighted base for holding the hair dryer holder 10 in place.

Also described is a method of fixing a portable hair dryer 20 having a handle portion 22 and blower portion 24 in place. The method includes providing a hair dryer holder 10 that includes a base portion 12, a retainer portion 14, and a ring 27. The handle portion 22 of the portable hair dryer 20 is inserted through an opening 28 in the retainer portion 14. If the blower portion is positioned on a raised section, the portable hair dryer is automatically rotated under the force of gravity so that the blower portion 24 is received within a recessed section in the retainer portion 14. The retainer portion 14 is finally adjusted to the preferred position.

According to this method, the base portion 12 of the hair dryer holder 10 includes structure for securing the hair dryer holder 10 to a surface, such as a wall or minor. This structure may be a permanent fastener, such as a screw or nail, or may be a temporary element, such as an opening for a hook or a suction cup for attachment to a mirror. Further, the base may be weighted to be independently supported.

In embodiments, the retainer portion 14 is pivotally attached to the base portion 12. The retainer portion 14 may be directly connected to the base portion 12 by means of a hinge, ball-and-socket, or other type of joint allowing at least one degree of freedom between the base portion 12 and retainer portion 14. Alternatively, an intermediary element, such as a flexible or rigid arm, may be provided between the base portion 12 and the retainer portion 14.

In embodiments, the retainer portion also includes an opening 28 for receiving the handle portion 22 of the portable hair dryer and a ring 27 for supporting the blower portion 14 of the portable hair dryer 20 in a fixed position. The ring 27 may include a plurality of recesses, such as those illustrated in FIG. 3A.

Also disclosed is a retainer for securing to a base a portable hair dryer having a handle portion and a blower portion. The retainer includes a ring for supporting a blower portion of the portable hair dryer, an opening for receiving the handle portion of the blow dryer, and a plurality of raised and recessed sections for supporting the blower portion in a fixed position.

The described hair dryer holder may also be useful for those having reduced or limited mobility. The holder allows for hands-free use of a hair dryer that may be positioned at a variety of angles and positions. This allows a person having reduced mobility to position the hair dryer at a preferred position and dry his or her hair at previously unattainable angles or positions. Such improved positioning and functionality allows for improved independence and convenience.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

While certain embodiments have been described, it must be understood that various changes may be made and equivalents may be substituted without departing from the spirit or scope of the present disclosure. In addition, many modifications may be made to adapt a particular situation or material to the teachings of the disclosure without departing from its spirit or scope.

What is claimed is:

1. A hair dryer holder for securing a hair dryer having a handle portion and a blower portion, the hair dryer holder comprising:
a base portion configured to secure the hair dryer holder to a surface; and
a retainer portion pivotally secured to the base portion and configured to hold the hair dryer in a fixed position,
wherein the retainer portion comprises an opening configured to receive the handle portion of the hair dryer and a ring extending at least partially around the opening,
the ring comprising a plurality of recessed sections with each of the plurality of recessed sections configured to support the blower portion of the portable hair dryer in a fixed position.

2. The hair dryer holder as claimed in claim 1, wherein the ring further comprises a top surface having rounded undulations defining a plurality of raised sections alternating between the plurality of recessed sections.

3. The hair dryer holder of claim 2, wherein the rounded undulations are sinusoidal.

4. The hair dryer holder as claimed in claim 1, wherein the ring further comprises a top surface having a textured surface defining the plurality of recessed sections.

5. The hair dryer holder as claimed in claim 1, wherein the ring further comprises a top surface defining a plurality of raised ridges alternating between the plurality of recessed sections.

6. The hair dryer holder as claimed in claim 1, wherein the ring further comprises a cord opening disposed opposite the base portion and configured to receive a cord of the hair dryer.

7. The hair dryer holder as claimed in claim 6, wherein the cord opening is sized to receive the handle portion of the hair dryer.

8. The hair dryer holder as claimed in claim 1, wherein the base portion includes a base opening configured to receive a fastener for securing the hair dryer holder to a surface.

9. The hair dryer holder as claimed in claim 8, wherein the fastener comprises a suction cup.

10. The hair dryer holder as claimed in claim 1 further comprising:
an arm pivotally secured to the base portion and connecting to the retainer portion, such that the retainer portion is pivotally secured to the base portion.

11. A method of fixing a hair dryer in place, the method comprising the steps of:
providing a hair dryer having a handle portion and a blower portion;
providing a hair dryer holder for supporting the hair dryer, the hair dryer holder including:
a base portion configured to secure the hair dryer holder to a surface; and
a retainer portion pivotally attached to the base portion and configured to hold the hair dryer in a fixed position, the retainer including an opening configured to receive the handle portion of the hair dryer and a ring extending at least partially around the opening, the ring comprising a plurality of recessed sections with each of the plurality of recessed sections configured to support the blower portion of the hair dryer in a fixed position;
inserting the handle of the portable hair dryer through the opening in the retainer portion of the holder;
automatically rotating the hair dryer so that the blower portion is received within one of the plurality of recessed sections; and
adjusting the position of the retainer portion.

12. The method as claimed in claim 11, wherein the base portion further comprises a fastener for securing the hair dryer holder to a surface.

13. The method as claimed in claim 11, wherein the ring further comprises a top surface having sinusoidal undulations defining a plurality of raised sections alternating between the plurality of recessed sections, and wherein the hair dryer is automatically rotated into one of the plurality of recessed sections by the force of gravity.

14. The method as claimed in claim 11, wherein the ring further comprises a cord opening disposed opposite the base portion and configured to receive a cord of the hair dryer.

15. The method as claimed in claim 11, wherein the ring further comprises a top surface having a textured surface defining the plurality of recessed sections, and wherein the hair dryer is automatically rotated into one of the plurality of recessed sections by the force of gravity.

16. The method as claimed in claim 11, wherein the hair dryer holder further comprises an arm pivotally secured to the base portion and connecting to the retainer portion, such that the retainer portion is pivotally secured to the base portion.

17. A retainer for securing a portable hair dryer having a handle portion and a blower portion to a base, the retainer comprising:
a ring for supporting the blower portion of the portable hair dryer;
an opening for receiving the handle portion of the portable hair dryer;
a plurality of raised and recessed sections for supporting the blower portion in a fixed position.

18. The retainer as claimed in claim 17, wherein the plurality of raised and recessed sections comprise sinusoidal undulations.
